(19) United States
(12) Patent Application Publication
(10) Pub. No.: US 2025/0101607 A1
(43) Pub. Date: Mar. 27, 2025

(54) ELECTROLYSIS DEVICE

(71) Applicant: KANEKA CORPORATION, Osaka-shi, Osaka (JP)

(72) Inventors: Mitsuyasu IMAZAKI, Settsu-shi, Osaka (JP); Mikihito SUGIYAMA, Takasago-shi, Hyogo (JP)

(21) Appl. No.: 18/702,077

(22) PCT Filed: Oct. 17, 2022
(86) PCT No.: PCT/JP2022/038542

§ 371 Date: Dec. 2, 2024

(30) Foreign Application Priority Data
Oct. 26, 2021 (JP) 2021-174960

(51) Int. Cl. C25B 9/19; B01D 61/46; C25B 3/26; C25B 11/032; C25B 11/051

(52) U.S. Cl. CPC C25B 9/19; B01D 61/461; C25B 11/032; C25B 11/051; B01D 2313/26; C25B 3/26

(57) ABSTRACT

The present invention provides an electrolysis device capable of recovering lithium from seawater, brine, recycled waste liquid, or the like containing lithium ions, and capable of generating a carbon compound from carbon dioxide. The electrolysis device including: a first electrode part; a second electrode part; a lithium ion exchanger; a first electrolyte solution; a second electrolyte solution containing lithium ions; and a first gas supply part capable of supplying a first carbon gas containing carbon dioxide, in which the first electrode part includes a catalyst layer, and the catalyst layer is in contact with the first electrolyte solution, the second electrode part is opposed to the first electrode part with the lithium ion exchanger interposed between the second electrode part and the first electrode part, and is in contact with the second electrolyte solution, the lithium ion exchanger is provided so as to partition the first electrolyte solution and the second electrolyte solution, and allows the lithium ions to selectively pass from the second electrolyte solution toward the first electrolyte solution, and carbon dioxide in the first carbon gas is reduced to produce a carbon compound different from carbon dioxide by applying a voltage between the first electrode part and the second electrode part in a state where the first carbon gas is supplied from the first gas supply part toward the first electrode part.

### TECHNICAL FIELD

The present invention relates to an electrolysis device capable of recovering lithium from seawater or the like and further reducing carbon dioxide.

### BACKGROUND ART

In recent years, in order to reduce an emission amount of carbon dioxide as a greenhouse gas, efforts have been made to generate a carbon compound from the emitted carbon dioxide and recycle the carbon dioxide (for example, Patent Document 1).

For example, an electrochemical reaction device of Patent Document 1 includes an anode section, a cathode section, a separator that separates the anode section and the cathode section, and a power supply. By applying a voltage between the anode section and the cathode section by the power supply, carbon dioxide is reduced in the cathode section to generate carbon compounds and hydrogen, and water and hydroxide ions are oxidized in the anode section to generate oxygen and hydrogen ions.

### PRIOR ART DOCUMENT

### Patent Document

Patent Document 1: JP6818920B2

### DISCLOSURE OF INVENTION

### Technical Problem

Incidentally, in recent years, with the spread of lithium ion secondary batteries, the demand for lithium has increased, and it is predicted that the supply of lithium will become insufficient in the future and the cost will increase.

Lithium has been conventionally mined in a mine, but on the other hand, it is known that lithium is contained in a large amount in seawater, and if lithium can be recovered from seawater, it is possible to meet future demand for lithium and to reduce the cost of lithium.

If a carbon compound can be produced from carbon dioxide as in Patent Document 1 while recovering lithium from seawater or the like, it is considered that a future demand for lithium can be met while contributing to the reduction of carbon dioxide.

Therefore, an object of the present invention is to provide an electrolysis device capable of recovering lithium from seawater, brine, recycled waste liquid, or the like containing lithium ions, and capable of generating a carbon compound from carbon dioxide.

### Solution to Problem

The present inventors use a stock solution containing lithium ions as an electrolyte solution on an anode side, and use a lithium ion conductive material that allows movement of only lithium ions as a separator. Then, it has been considered that by applying a voltage between an anode and a cathode, only lithium ions can be transferred from the stock solution on the anode side to a recovery liquid on a cathode side using a potential difference between the anode and the cathode while carbon dioxide is reduced at the cathode to generate a carbon compound, and lithium can be recovered from the recovery liquid while power for generating the carbon compound is used without waste.

One aspect of the present invention derived based on the above idea is an electrolysis device including: a first electrode part; a second electrode part; a lithium ion exchanger; a first electrolyte solution; a second electrolyte solution containing lithium ions; and a first gas supply part capable of supplying a first carbon gas containing carbon dioxide, in which the first electrode part includes a catalyst layer, and the catalyst layer is in contact with the first electrolyte solution, the second electrode part is opposed to the first electrode part with the lithium ion exchanger interposed between the second electrode part and the first electrode part, and is in contact with the second electrolyte solution, the lithium ion exchanger is provided so as to partition the first electrolyte solution and the second electrolyte solution, and allows the lithium ions to selectively pass from the second electrolyte solution toward the first electrolyte solution, and carbon dioxide in the first carbon gas is reduced to produce a carbon compound different from carbon dioxide by applying a voltage between the first electrode part and the second electrode part in a state where the first carbon gas is supplied from the first gas supply part toward the first electrode part.

The term “carbon compound” as used herein refers to a compound containing carbon, and includes not only organic compounds but also oxides such as carbon monoxide, carbonates, and carbides. The same applies hereinafter.

According to this aspect, the lithium ions contained in the second electrolyte solution pass through the lithium ion exchanger, move to the first electrolyte solution, and are concentrated in the first electrolyte solution. Therefore, by adding a precipitant or the like, the lithium ions in the first electrolyte solution can be precipitated and the like to recover lithium.

According to this aspect, since carbon dioxide in the first carbon gas can be reduced to produce a carbon compound, the carbon compound can be produced while consuming carbon dioxide.

In a preferred aspect, the catalyst layer is laminated on a gas diffusion electrode in the first electrode part, and the first gas supply part supplies the first carbon gas to a side of the gas diffusion electrode opposite to the catalyst layer.

According to this aspect, since the gas diffusion electrode is used, hydrogen is less likely to be generated on the first electrode part, and a larger amount of carbon compound can be generated.

In a preferred aspect, the lithium ion exchanger is a lithium ion conductive solid electrolyte.

According to this aspect, since the lithium ion exchanger is formed of the solid electrolyte, durability is high as compared with the case of using a resin ion exchange membrane.

In a preferred aspect, the second electrolyte solution contains lithium chloride or lithium sulfate.

According to this aspect, ionization is likely to occur in the second electrolyte solution, and a lithium ion state is likely to occur.

In a preferred aspect, the second electrolyte solution is seawater.

According to this aspect, since seawater is used as the second electrolyte solution, lithium can be recovered at low cost.

According to this aspect, since chloride ions are contained, chlorine can also be generated on the second electrode part.

In a preferred aspect, the first electrolyte solution is an alkaline aqueous solution.

According to this aspect, the reduction reaction of carbon dioxide can be efficiently advanced.

In a more preferable aspect, the first electrolyte solution contains a lithium hydroxide aqueous solution.

According to this aspect, impurities are hardly generated in the first electrolyte solution.

In a preferred aspect, a second gas supply part that supplies a second carbon gas containing carbon dioxide to the first electrolyte solution is provided.

According to this aspect, lithium can be recovered as a precipitate of lithium carbonate by supplying the second carbon gas in a state where lithium ions are concentrated at a high concentration in the first electrolyte solution.

In a preferred aspect, the carbon compound is a C1 compound or a C2 compound.

The “C1 compound” as used herein refers to a carbon compound having one carbon atom, and for example, refers to methane, carbon monoxide, methanol, and the like.

The “C2 compound” as used herein refers to a carbon compound having two carbon atoms, and for example, refers to ethane, ethanol, ethylene, and the like.

According to this aspect, it is easy to be generated from carbon dioxide.

### Effect of Invention

According to the electrolysis device of the present invention, lithium can be recovered from seawater or waste liquid containing lithium ions, and a carbon compound can be generated from carbon dioxide.

### BRIEF DESCRIPTION OF DRAWINGS

FIG. 1 is a cross-sectional view conceptually illustrating an electrolysis device according to a first embodiment of the present invention.

FIG. 2 is a cross-sectional view conceptually illustrating an electrolysis device according to a second embodiment of the present invention.

FIG. 3 is a cross-sectional view of the electrolysis device of FIG. 2 in an electrolysis step.

FIG. 4 is a cross-sectional view of the electrolysis device in FIG. 2 in a precipitation step.

### BEST MODE FOR CARRYING OUT THE INVENTION

Hereinafter, embodiments of the present invention will be described in detail.

An electrolysis device 1 according to a first embodiment of the present invention recovers lithium from an electrolyte solution 8 such as seawater or a waste liquid containing lithium ions, and further generates a carbon compound different from carbon dioxide from a first carbon gas containing carbon dioxide.

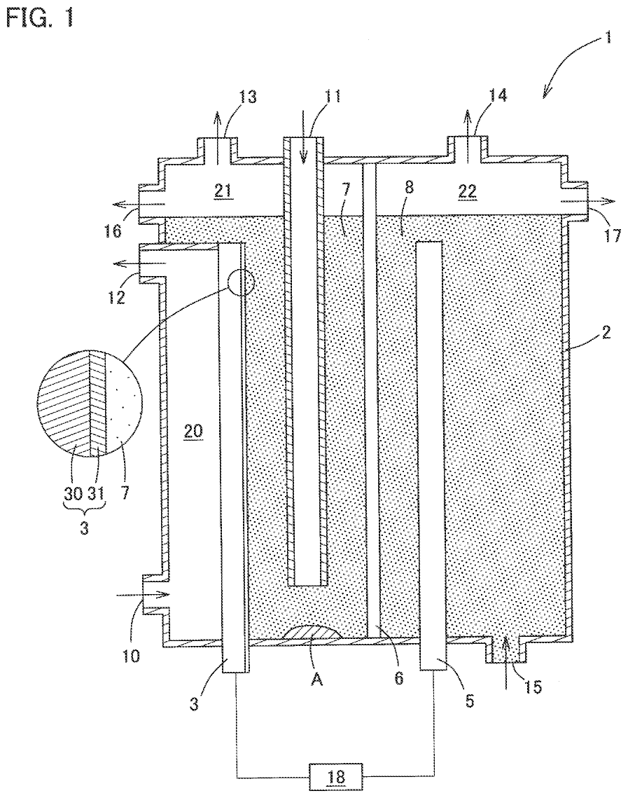

As illustrated in FIG. 1, the electrolysis device 1 includes an electrolytic cell 2, a first electrode part 3, a second electrode part 5, a lithium ion exchanger 6, a first electrolyte solution 7, a second electrolyte solution 8, a first gas supply part 10, a second gas supply part 11, a first gas discharge part 12, a second gas discharge part 13, a third gas discharge part 14, an electrolyte solution introduction unit 15, a first electrolyte solution discharge part 16, a second electrolyte solution discharge part 17, and a power supply part 18, and the inside of the electrolytic cell 2 is partitioned into three spaces 20 to 22 by the first electrode part 3 and the lithium ion exchanger 6.

The first electrode part 3 is a cathode electrode for reducing the first carbon gas containing carbon dioxide, and has resistance to the first electrolyte solution 7.

As illustrated in an enlarged view of FIG. 1, the first electrode part 3 is formed by laminating a catalyst layer 31 on a gas diffusion electrode 30.

The gas diffusion electrode 30 is a porous substrate having conductivity, and is capable of allowing a gas to transmit in a thickness direction.

The catalyst layer 31 includes one or a plurality of catalysts, and can reduce carbon dioxide to a C1 compound and/or a C2 compound (carbon compound) depending on the type of the catalyst.

In a case where carbon monoxide as the C1 compound is generated, Ni—N—C, Ag, Ag—S—C₃N₄/CNT, CoPc-CN/CNT, CoOₓ/CNT, or the like can be used as the catalyst layer 31.

As the catalyst layer 31, Sn, Bi, SnO₂/CNT, or the like can be used in the case of producing a formate which is the C1 compound.

For the catalyst layer 31, Cu, Cu-MOF, Cu (ERD), Cu, or the like can be used in the case of producing ethylene which is the C2 compound.

As the catalyst layer 31, Cu₂O/ZnO or the like can be used in the case of producing methanol which is the C1 compound.

As the catalyst layer 31, Cu₂S/Cu—V, CuZn, or the like can be used in the case of producing ethanol which is the C2 compound.

The second electrode part 5 is a counter electrode paired with the first electrode part 3, and is an anode electrode that oxidizes the second electrolyte solution 8.

The second electrode part 5 is an electrode having resistance to the second electrolyte solution 8 and corrosion resistance to chlorine, and for example, a metal electrode such as a platinum electrode can be used.

The lithium ion exchanger 6 is a cation exchanger that has lithium ion conductivity and allows only movement of lithium ions from a side of the second electrolyte solution 8 to a side of the first electrolyte solution 7.

The lithium ion exchanger 6 is not particularly limited as long as it has lithium ion conductivity.

As the lithium ion exchanger 6, for example, a lithium ion conductive solid electrolyte such as lithium aluminum titanium phosphate (LATP) having a NASICON-type crystal structure or lithium lanthanum titanate (LLTO) having a perovskite-type crystal structure can be used.

The lithium ion exchanger 6 may be made of a resin lithium ion conductive material such as a cation exchange membrane, but is preferably made of a lithium ion conductive solid electrolyte from the viewpoint of durability.

Furthermore, in a case where the lithium ion conductive solid electrolyte is used, the lithium ion exchanger 6 may include a buffer layer formed on a surface thereof to promote movement of lithium ions into the lithium ion conductive solid electrolyte and movement of lithium ions from the lithium ion conductive solid electrolyte.

The lithium ion exchanger 6 may be a composite of a solid electrolyte and a polymer membrane, or may be a metal organic framework.

Furthermore, the lithium ion exchanger 6 may include an adsorbent that selectively adsorbs specific ions other than lithium ions.

The first electrolyte solution 7 does not substantially react with lithium ions and can maintain lithium ions in an ionic state, and for example, an alkaline aqueous solution such as a lithium hydroxide aqueous solution (LiOH) or a sodium hydroxide aqueous solution (NaOH), or an acidic aqueous solution such as hydrochloric acid (HCl) can be used.

The first electrolyte solution 7 of the present embodiment is preferably lithium hydroxide solution from the viewpoint of precipitating a lithium carbonate A with the second carbon gas.

The second electrolyte solution 8 contains a lithium salt, and it is maintained as lithium ions in a liquid such as an aqueous solution, an organic solvent, or an ionic liquid.

As the second electrolyte solution 8, for example, seawater containing lithium ions, recycled waste liquid such as waste liquid of a lithium ion secondary battery, treated water of lithia ore, brine water not suitable for lithium production, and the like can be used.

Examples of the lithium salt contained in the second electrolyte solution 8 include lithium chloride and lithium sulfate.

The second electrolyte solution 8 of the present embodiment uses seawater and contains lithium chloride as a lithium salt.

The first gas supply part 10 is a part that supplies the first carbon gas containing carbon dioxide to the first space 20.

The first carbon gas is a gas whose main component is configured of carbon dioxide, and carbon dioxide preferably occupies 80% or more of all components, and carbon dioxide more preferably occupies 95% or more of all components.

The term “main component” as used herein refers to a component that accounts for more than 50% of the whole. The same applies hereinafter.

The second gas supply part 11 is a part for supplying the second carbon gas containing carbon dioxide to the second space 21, and includes a nozzle extending vertically in a cylindrical shape.

The second carbon gas is a gas whose main component is configured of carbon dioxide, and carbon dioxide preferably occupies 80% or more of all components, and carbon dioxide more preferably occupies 95% or more of all components.

The first gas discharge part 12 is a part that discharges gas from the first space 20 to an external storage tank (not illustrated), and can discharge gas (for example, carbon dioxide, a carbon compound, and the like) in the first space 20 to the external storage tank.

The second gas discharge part 13 is a part that discharges gas from the second space 21 to an external storage tank (not illustrated), and can discharge gas (for example, carbon dioxide, a carbon compound, hydrogen, and the like) in the second space to the external storage tank.

The third gas discharge part 14 is a part that discharges gas from the third space 22 to an external storage tank (not illustrated), and can discharge gas (for example, chlorine, oxygen, and the like) in the third space to the external storage tank.

The electrolyte solution introduction part 15 is a part for introducing the second electrolyte solution 8 into the third space 22 from an external electrolyte solution supply source (not illustrated).

The first electrolyte solution discharge part 16 is a part for discharging the first electrolyte solution 7 from the second space 21 to an external storage tank (not illustrated).

When a liquid level of the first electrolyte solution 7 reaches a predetermined height, the first electrolyte solution discharge part 16 can discharge the first electrolyte solution 7 to the external storage tank (not illustrated) so that the first electrolyte solution 7 does not exceed the predetermined height.

The second electrolyte solution discharge part 17 is a part for discharging the second electrolyte solution 8 from the third space 22 to an external storage tank (not illustrated).

When a liquid level of the second electrolyte solution 8 reaches a predetermined height, the second electrolyte solution discharge part 17 can discharge the second electrolyte solution 8 to the outside so that the second electrolyte solution 8 does not exceed the predetermined height.

The power supply part 18 is a part that applies a predetermined voltage between the first electrode part 3 and the second electrode part 5.

The power supply part 18 may apply a voltage by commercial power, or may apply a voltage by renewable energy generated by a power supply part such as a solar cell or a fuel cell.

The first space 20 is a space constituting a first gas flow path of the first carbon gas from the first gas supply part 10 to the first gas discharge part 12, and is a space in which a part between the first gas supply part 10 and the first gas discharge part 12 is partitioned by the first electrode part 3.

The second space 21 is a space partitioned from the first space 20 by the first electrode part 3 and partitioned from the third space 22 by the lithium ion exchanger 6.

The third space 22 is a space partitioned from the second space 21 by the lithium ion exchanger 6.

Subsequently, a positional relationship of each part of the electrolysis device 1 according to the present embodiment will be described.

In the electrolysis device 1, as illustrated in FIG. 1, the first electrode part 3 is opposed to the second electrode part 5 with the lithium ion exchanger 6 interposed therebetween.

Specifically, in the electrolysis device 1, the electrode parts 3 and 5 stand upright from a bottom face of the electrolytic cell 2 toward a top face side, and the catalyst layer 31 side of the first electrode part 3 faces the lithium ion exchanger 6. That is, in the first electrode part 3, the gas diffusion electrode 30 side is exposed to the first space 20, and the catalyst layer 31 side is exposed to the second space 21.

In the electrolysis device 1, the first gas supply part 10 is provided below the first gas discharge part 12 in the first space 20, and a first gas flow path for guiding the first carbon gas from the first gas supply part 10 to the first gas discharge part 12 via the first space 20 is formed.

Furthermore, in the electrolysis device 1, the gas diffusion electrode 30 of the first electrode part 3 is exposed in the middle of the first gas flow path.

In the electrolysis device 1, the second gas supply part 11 extends from the top face to the vicinity of the bottom face of the electrolytic cell 2 in the second space 21, the second gas discharge part 13 is provided on the top face of the electrolytic cell 2, and the first electrolyte solution discharge part 16 is provided on a side face of the electrolytic cell 2.

That is, in the electrolysis device 1, a second gas flow path for returning the second carbon gas from the second gas supply part 11 in the vicinity of the bottom face and guiding the second carbon gas to the second gas discharge part 13 is formed, and when the first electrolyte solution 7 fills the second space 21 up to the height of the first electrolyte solution discharge part 16, a part of the first electrolyte solution 7 is discharged from the first electrolyte solution discharge part 16 to the outside.

Furthermore, in electrolysis device 1, the catalyst layer 31 of the first electrode part 3 is exposed in the middle of the second gas flow path.

In the electrolysis device 1, the third gas discharge part 14 is provided on the top face of the electrolytic cell 2 in the third space 22, the electrolyte solution introduction part 15 is provided on the bottom face of the electrolytic cell 2, and the second electrolyte solution discharge part 17 is provided on the side face of the electrolytic cell 2.

In the electrolysis device 1, when the second electrolyte solution 8 introduced from the electrolyte solution introduction part 15 fills the third space 22 up to the height of the second electrolyte solution discharge part 17, a part of the second electrolyte solution 8 is discharged from the second electrolyte solution discharge part 17 to the external storage tank.

Subsequently, an electrolysis method using the electrolysis device 1 of the present embodiment will be described.

The electrolysis method of the electrolysis device 1 of the present embodiment includes an electrolysis step and a precipitation step.

The electrolysis step may be performed simultaneously with or separately from the precipitation step.

In the following description, a case where the electrolysis step and the precipitation step are separately and independently performed, and the precipitation step is performed after the electrolysis step will be described.

### (Electrolysis Step)

In the electrolysis step, a voltage is applied between the first electrode part 3 and the second electrode part 5 by the power supply part 18, carbon dioxide in the first carbon gas is reduced on the first electrode part 3 to generate a carbon compound, and chloride ions are oxidized on the second electrode part 5 to generate chlorine gas.

Specifically, chloride ions around the second electrolyte solution 8 are oxidized by a potential difference between the first electrode part 3 and the second electrode part 5 generated by the power supply part 18, lithium ions in the second electrolyte solution 8 pass through the lithium ion exchanger 6 to reach the first electrolyte solution 7, and the lithium ions are concentrated in the first electrolyte solution 7. Furthermore, on the first electrode part 3, carbon dioxide in the first carbon gas passing through the first gas flow path is reduced at a three-layer interface between the catalyst layer 31 and the first electrolyte solution 7, and a carbon compound is generated. Note that in a case where the carbon compound produced on the first electrode part 3 is water-soluble, the carbon compound is dissolved in the first electrolyte solution 7 and accumulated in the first electrolyte solution 7, and in a case where the carbon compound produced on the first electrode part 3 is water-insoluble, the carbon compound passes through the first gas flow path and is discharged from the first gas discharge part 12 to the external storage tank, or passes through the second gas flow path and is discharged from the second gas discharge part 13 to the external storage tank.

Here, in the electrolysis step, as the reaction proceeds, lithium ions in the second electrolyte solution 8 move to the first electrolyte solution 7, and the concentration of the lithium ions in the first electrolyte solution 7 increases.

When the concentration in the first electrolyte solution 7 reaches a certain concentration, the electrolysis step is stopped or terminated, and the process proceeds to the precipitation step.

### (Precipitation Step)

In the precipitation step, the second carbon gas is introduced into the first electrolyte solution 7 to react the second carbon gas with the first electrolyte solution 7, and the lithium carbonate A is precipitated.

Specifically, in the precipitation step, the second carbon gas is supplied from the second gas supply part 11 to the first electrolyte solution 7 in which lithium ions are concentrated by the electrolysis step.

Then, as in the following reaction formula, lithium hydroxide (lithium ions and hydroxide ions) occupying the first electrolyte solution 7 reacts with carbon dioxide, and the lithium carbonate A is precipitated.

CO₂+2Li⁺+2OH⁻→Li₂CO₃+H₂O

When the lithium carbonate A is sufficiently produced, the precipitation step is stopped or terminated, and the process proceeds to the electrolysis step as necessary.

The electrolysis step and the precipitation step are repeated as necessary to reduce carbon dioxide in the first carbon gas to a carbon compound and recover lithium as the lithium carbonate A.

According to the electrolysis device 1 of the first embodiment, since lithium ions contained in the second electrolyte solution 8 pass through the lithium ion exchanger 6 and move to the first electrolyte solution 7, the lithium ions in the first electrolyte solution 7 are concentrated, and thus, lithium can be recovered by precipitating or the like the lithium ions in the first electrolyte solution 7 with a precipitant or the like.

According to the electrolysis device 1 of the first embodiment, since carbon dioxide in the first carbon gas can be reduced to produce a carbon compound, the carbon compound can be produced while consuming carbon dioxide.

According to the electrolysis device 1 of the first embodiment, since seawater is used as the second electrolyte solution 8, the environmental load is small, and lithium can be recovered at low cost. Furthermore, chlorine gas can also be generated.

According to the electrolysis device 1 of the first embodiment, since carbon dioxide in the second carbon gas functions as a precipitant for precipitating lithium ions in the first electrolyte solution 7, more carbon dioxide can be consumed.

According to the electrolysis device 1 of the present embodiment, since the electrolysis device 1 is partitioned by the gas diffusion electrode 30 of the first electrode part 3, the water-soluble carbon compound is dissolved in the first electrolyte solution 7, and the water-insoluble carbon compound is discharged from the first gas discharge part 12. Therefore, the produced carbon compound can be separated into water-soluble and water-insoluble carbon compounds.

Subsequently, an electrolysis device 100 according to a second embodiment of the present invention will be described. Note that the same reference signs are given to the same configurations as those of the electrolysis device 1 of the first embodiment, and the description thereof will be omitted.

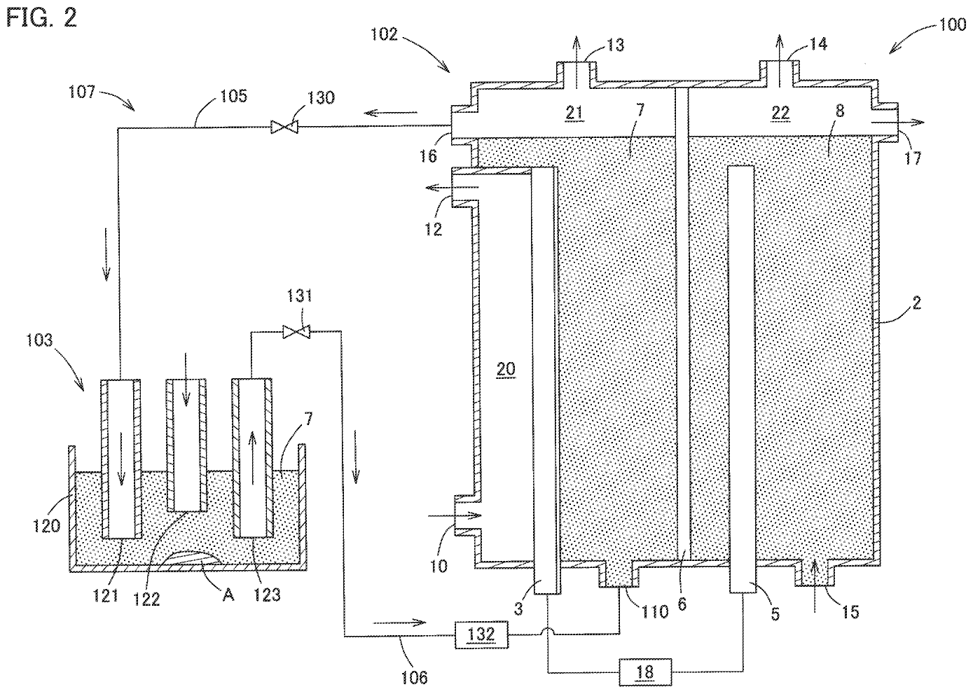

As illustrated in FIG. 2, the electrolysis device 100 includes an electrolytic part 102, a precipitation part 103, a first path 105, and a second path 106, and a circular circulation flow path 107 formed by the electrolytic part 102, the first path 105, the precipitation part 103, and the second path 106.

### (Electrolytic Part 102)

The electrolytic part 102 includes the electrolytic cell 2, the first electrode part 3, the second electrode part 5, the lithium ion exchanger 6, the first electrolyte solution 7, the second electrolyte solution 8, the first gas supply part 10, the first gas discharge part 12, the second gas discharge part 13, the third gas discharge part 14, a first electrolyte solution introduction part 110, the second electrolyte solution introduction part 15, the first electrolyte solution discharge part 16, the second electrolyte solution discharge part 17, and the power supply part 18.

The first electrolyte solution introduction part 110 is a part that is provided on a bottom face of the electrolytic cell 2 and introduces the first electrolyte solution 7 into a second space 21 from the second path 106.

The first electrolyte solution discharge part 16 discharges the first electrolyte solution 7 from the second space 21 to the first path 105.

### (Precipitation Part 103)

As illustrated in FIG. 2, the precipitation part 103 includes a precipitation cell 120, a third electrolyte solution introduction part 121, a second gas supply part 122, and a third electrolyte solution discharge part 123.

The third electrolyte solution introduction part 121 is a part that introduces the first electrolyte solution 7 into the precipitation cell 120 from the second space 21 via the first path 105.

Similarly to the second gas supply part 11 of the first embodiment, the second gas supply part 122 is a part for supplying the second carbon gas containing carbon dioxide to the precipitation cell 120, and includes a nozzle extending vertically in a cylindrical shape.

The third electrolyte solution discharge part 123 is a part for discharging the first electrolyte solution 7 from the inside of the precipitation cell 120 to the second path 106.

The first path 105 is a connection pipe connecting the first electrolyte solution discharge part 16 of the electrolytic part 102 and the third electrolyte solution introduction part 121 of the precipitation part 103, and includes an on-off valve 130 in the middle.

The second path 106 is a connection pipe connecting the third electrolyte solution discharge part 123 of the precipitation part 103 and the first electrolyte solution introduction part 110 of the electrolytic part 102, and includes an on-off valve 131 and a circulation pump 132 in the middle.

The circulation pump 132 can supply the first electrolyte solution 7 to a downstream side at a predetermined flow rate.

Next, an electrolysis method using the electrolysis device 100 of the present embodiment will be described.

The electrolysis device 100 according to the second embodiment is configured by an electrolysis step and a precipitation step similarly to the electrolysis device 1 according to the first embodiment, and is different from the electrolysis device 1 according to the first embodiment in that a part that performs the electrolysis step and a part that performs the precipitation step are different.

### (Electrolysis Step)

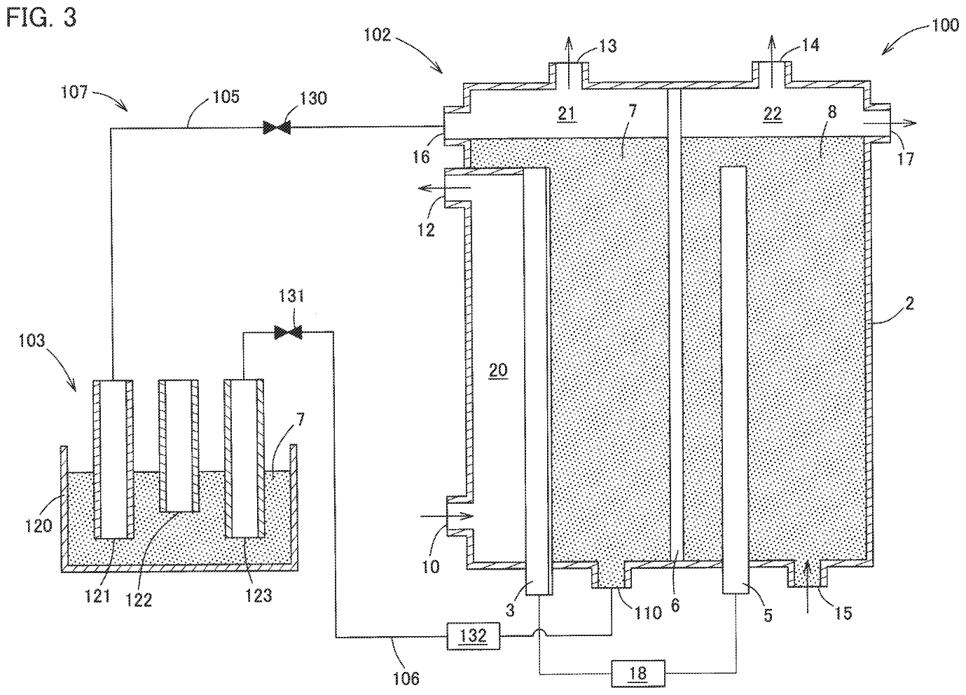

In the electrolysis step of the electrolysis device 100, as illustrated in FIG. 3, the on-off valves 130 and 131 are closed to stop the circulation of the first electrolyte solution 7 in the circulation flow path 107, and in this state, similarly to the electrolysis step, a voltage is applied between the first electrode part 3 and the second electrode part 5 by the power supply part 18 to generate a carbon compound on the first electrode part 3 and generate chlorine gas on the second electrode part 5.

When the concentration in the first electrolyte solution 7 reaches a certain concentration, the precipitation step is performed in parallel.

### (Precipitation Step)

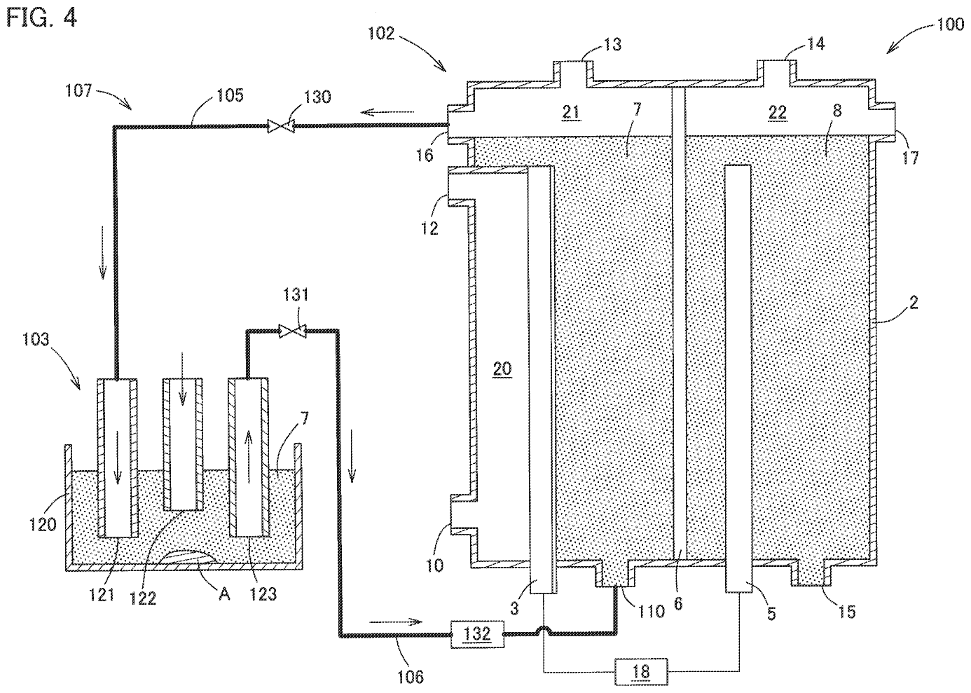

In the precipitation step, as illustrated in FIG. 4, the on-off valves 130 and 131 are opened, the circulation pump 132 is driven to introduce the first electrolyte solution 7 in the precipitation cell 120 from the first electrolyte solution introduction part 110 into the second space 21 via the second path 106, and the first electrolyte solution 7 overflowing from the first electrolyte solution discharge part 16 by the first electrolyte solution 7 introduced from the first electrolyte solution introduction part 110 is introduced into the precipitation cell 120 from the third electrolyte solution introduction part 121 via the first path 105.

In this manner, the first electrolyte solution 7 in the precipitation cell 120 is replaced with the first electrolyte solution 7 containing lithium ions at a high concentration, and the second carbon gas is supplied from the second gas supply part 122 to the first electrolyte solution 7.

Then, lithium hydroxide (lithium ions and hydroxide ions) occupying the first electrolyte solution 7 reacts with carbon dioxide to precipitate the lithium carbonate A.

When the lithium carbonate A is sufficiently produced, the precipitation step is stopped or terminated.

According to the electrolysis device 100 of the second embodiment, the electrolytic cell 2 and the precipitation cell 120 are separately provided, and lithium is precipitated as the lithium carbonate A in the precipitation cell 120 outside the electrolytic cell 2. Therefore, lithium can be recovered in the precipitation cell 120 without stopping the electrolysis step in the electrolytic part 102.

According to the electrolysis device 100 of the second embodiment, since the first electrolyte solution 7 is circulated in the circulation flow path 107 to recover lithium, lithium can be recovered at low cost.

In the embodiment described above, carbon dioxide is used as a precipitant that precipitates the lithium carbonate A, but the present invention is not limited thereto. Other precipitants may be used.

In the first embodiment described above, the electrolysis step and the precipitation step are separate steps, but the present invention is not limited thereto. The electrolysis step and the precipitation step may be performed simultaneously.

That is, the second carbon gas may be supplied by the second gas supply part 11 in a state where the electrolysis is performed in the electrolysis step to precipitate the lithium carbonate A.

In the second embodiment described above, the electrolysis step and the precipitation step are performed in parallel, but the present invention is not limited thereto. The electrolysis step and the precipitation step may be performed separately.

In the second embodiment described above, the first electrolyte solution 7 is returned from the precipitation part 103 to the electrolytic part 102 by the second path 106, but the present invention is not limited thereto. The first electrolyte solution 7 after the precipitation step may be discharged as it is to an external storage tank.

In this case, it is preferable that second path 106 is connected to an external electrolyte solution supply source, and the first electrolyte solution 7 is supplied from the electrolyte solution supply source into the second space 21 of the electrolytic part 102 via the first electrolyte solution introduction part 110.

In the embodiments described above, the second carbon gas containing carbon dioxide is supplied from the second gas supply part 11 or 122 to the second space 21 or the precipitation cell 120, and lithium is precipitated as the lithium carbonate A, but the present invention is not limited thereto. Another precipitant other than the second carbon gas may be added from the second gas supply part 11 or 122 to precipitate lithium as a lithium precipitate. In this case, the second gas supply part 11 or 122 functions as a precipitant supply part that supplies a solid, liquid, or gas precipitant.

In the embodiment described above, each component member can be freely replaced or added between the embodiments as long as it is included in the technical scope of the present invention.

REFERENCE CHARACTER LIST
1, 100: Electrolysis device
3: First electrode part
5: Second electrode part
6: Lithium ion exchanger
7: First electrolyte solution
8: Second electrolyte solution
10: First gas supply part
11, 122: Second gas supply part
30: Gas diffusion electrode
31: Catalyst layer

1. An electrolysis device comprising: a first electrode part; a second electrode part; a lithium ion exchanger; a first electrolyte solution; a second electrolyte solution containing lithium ions; and a first gas supply part capable of supplying a first carbon gas containing carbon dioxide, wherein
the first electrode part includes a catalyst layer, and the catalyst layer is in contact with the first electrolyte solution,
the second electrode part is opposed to the first electrode part with the lithium ion exchanger interposed between the second electrode part and the first electrode part, and is in contact with the second electrolyte solution,
the lithium ion exchanger is provided so as to partition the first electrolyte solution and the second electrolyte solution, and allows the lithium ions to selectively pass from the second electrolyte solution toward the first electrolyte solution, and
carbon dioxide in the first carbon gas is reduced to produce a carbon compound different from carbon dioxide by applying a voltage between the first electrode part and the second electrode part in a state where the first carbon gas is supplied from the first gas supply part toward the first electrode part.

2. The electrolysis device according to claim 1, wherein
the catalyst layer is laminated on a gas diffusion electrode in the first electrode part, and
the first gas supply part supplies the first carbon gas to a side of the gas diffusion electrode opposite to the catalyst layer.

3. The electrolysis device according to claim 1 or 2, wherein the lithium ion exchanger is a lithium ion conductive solid electrolyte.

4. The electrolysis device according to any one of claims 1 to 3, wherein the second electrolyte solution contains lithium chloride or lithium sulfate.

5. The electrolysis device according to any one of claims 1 to 4, wherein the second electrolyte solution is seawater.

6. The electrolysis device according to any one of claims 1 to 5, wherein the first electrolyte solution is an alkaline aqueous solution.

7. The electrolysis device according to claim 6, wherein the first electrolyte solution contains a lithium hydroxide aqueous solution.

8. The electrolysis device according to any one of claims 1 to 7, further comprising a second gas supply part that supplies a second carbon gas containing carbon dioxide to the first electrolyte solution.

9. The electrolysis device according to any one of claims 1 to 8, wherein the carbon compound is a C1 compound or a C2 compound.
